(19) United States
(12) Patent Application Publication
(10) Pub. No.: US 2013/0152068 A1
(43) Pub. Date: Jun. 13, 2013

(54) Local Server Management of Software Updates to End Hosts Over Low Bandwidth, Low Throughput Channels

(71) Applicant: International Business Machines Corporation, Armonk, NY (US)

(72) Inventors: Igor Crk, Fairview Heights, IL (US); Larry Juarez, Tucson, AZ (US)

(73) Assignee: INTERNATIONAL BUSINESS MACHINES CORPORATION, Armonk, NY (US)

(21) Appl. No.: 13/759,276

(22) Filed: Feb. 5, 2013

Related U.S. Application Data
(63) Continuation of application No. 13/037,986, filed on Mar. 1, 2011.

(51) Int. Cl. G06F 9/445

(52) U.S. Cl. 717/172

(57) ABSTRACT

Various system embodiments for updating software on end hosts in computing environments and particularly storage environments are provided. A remote server pushes the software update image to and through a local server via a network connection and high-throughput channels and to the end host via low-throughput channels. The local server manages the update process; the remote server simply pushes the software update image and the end host simply receives and applies an update. The local server stares the current software image running on the end host and decides whether it is more efficient to simply send the software update image on or to create, send and apply a patch at the end host. This approach reduces the update time of the end host, reduces any disruption of normal message traffic to and from the end host and simplifies patch management.

### CROSS REFERENCE TO RELATED APPLICATION

This application is a continuation and claims benefit under 35 U.S.C. Section 120 of the following co-pending and commonly-assigned U.S. Utility Patent Application, which is incorporated by reference herein: U.S. patent application Ser. No. 13/037,986, tiled on Mar. 1, 2011, entitled. “LOCAL SERVER MANAGEMENT OF SOFTWARE UPDATES TO END HOSTS OVER LOW BANDWIDTH, LOW THROUGHPUT CHANNELS,”

### BACKGROUND

1. Field of the Invention

The present invention relates to a computer-network architecture for updating, software at an end host, and more specifically, to local server management of the transfer and application of a software update image over a low bandwidth, low throughput channel to efficiently update the end host The architecture is well suited to a storage area network that connects local servers to one or more storage systems via high-throughput channels. The network is supported by a power subsystem including multiple redundant rack power controllers (RPC) and primary power supplies (PPS) that are connected via low-throughput channels. The architecture is particularly well suited to update software on the RPCs or PPSs as the “end host”.

### 2. Description of the Related Art

A computer-network architecture may include one or more computers or local systems interconnected by a network. The network connection may include, for example, a local-area-network (LAN), a wide-area-network (WAN), the Internet, an intranet, or the like. In certain embodiments, the computers may include, both client computers and server computers. In general, client computers may initiate communication sessions, whereas local server computers may wait for requests from the client computers. In certain embodiments, the computers and/or local servers may connect to one or more internal or external direct-attached storage s).rstems (e.g., hard disk drives, solid-state drives, tape drives, etc). These computers and direct-attached storage devices may communicate using protocols such as ATA, SATA, SCSI, SAS, Fibre Channel, or the like on high-throughput channels.

The computer-network architecture may, in certain embodiments, include a storage network behind the local servers, such as a storage-area-network (SAN) or a LAN (e.g., when using network-attached storage). This network may connect the servers to one or more storage systems, such as individual hard disk drives or solid, state drives, arrays of hard disk drives or solid-state drives, tape drives, tape libraries, CD-ROM libraries, or the like. Where the network is a SAN, the servers and storage systems may communicate using a high-throughput networking standard such as Fibre Channel (FC).

An embodiment of a storage system may include a hardware management controller (HMC), a storage controller, one or more storage devices and a power subsystem. The storage controller will typically include multiple redundant local servers. The HMC, local servers and storage devices are interconnected via high-throughput channels such as Ethernet or Fibre Channel in order to move high-volume data rapidly to meet customer demands. The power subsystem typically includes multiple redundant power supplies for providing power to various components of the storage system and multiple redundant rack power controllers (RPCs) for formatting and routing message traffic and low-volume data between the power subsystem and the local servers. The power supply and RPC operate semi-autonomously with minimal message traffic to the local servers to periodically confirm that they are present and operational. Accordingly, the power supply and RPC are interconnected to the servers via low-throughput channels such as a two-wire I2C bus to support the normal message traffic.

As is common with most modern electronic devices, the HMC, local servers, storage devices, power supply and rack power controller all run some type of software. In general the devices, may run “firmware” that controls the basic functionality of the hardware and is specially tailor to a specific piece of hardware or “software” that controls higher-level functionality that is hardware agnostic. The software or firmware is provided as an “image” of the compiled software. From time-to-time, the software or firmware resident on the devices must be updated. A software update image is sent from a remote server over the network connection to the storage system where the image is distributed via the local channels to the specified device, the “end host”. The software update image replaces the current software image running on that end host. In many instances, the end host may run only a single instance of software.

### BRIEF SUMMARY

To achieve greater performance and reliability for customers, a variety of improvements to computing environments and more particularly storage environments continue to be made.

In view of the foregoing, various system embodiments for updating software on end hosts in computing environments and particularly storage environments. A remote server pushes the software update image to and through a local server via a network connection and high-throughput channels and to the end host via low-throughput channels. The local server manages the update process; the remote server simply pushes the software update image and the end host simply receives and applies an update. The local server stores the current software image running on the end host and decides whether it is more efficient to simply send the software update image on or to create, send and apply a patch at the end host.

According to one embodiment of the present invention, the software update image is pushed from a remote server over a network connection to a local system where it is routed via high-throughput channels and stored in the local server memory with a copy of the current software image now running on the end host. The high-throughput channels such as Ethernet or Fibre Channel connections have a throughput of at least one hundred times the throughput of the low-throughput channels such as I2C. The local server's update processor creates a patch to update the current software image to the software update image and calculates update times to transfer and apply either the software update image or the patch. The update processor pushes the software update image or patch having the shortest update time via the low-throughput channel to the end host. The end host processor applies the patch (if received) to the current software image to create the software update image or simply stores the received software update image. The end host processor replaces the current software image with the software update image to operate the end host. Once updated, the local server deletes the current software image and patch, maintaining only the updated software image as the current software image.

According to one embodiment of the present invention, an apparatus for updating software comprises a local storage system at a local customer site. The local storage system comprises a hardware management controller (HMC), one or more local servers each comprising an update processor and a memory, one or more storage devices, one or more rack power controllers (RPCs) comprising a memory that stores a current software image and a processor that executes that image to operate the RPC including communicating normal message traffic with the local server, and one or more power supplies. The local server memory stores a copy of the current software image running, on the end host. The HMC, local servers and storage devices are interconnected via high-throughput channels with the power supplies and the RPCs interconnected to the local servers via low-throughput channels. The high-throughput channels such as Ethernet or Fibre Channel connections have a throughput of at least one hundred times the throughput of the low-throughput channels such as I2C. A remote server pushes the software update image over an Internet connection to the local storage system with the HMC distributing the software update image via, the high-throughput channels to the local servers for storage in their memory. The local server's update processor creates a patch from the current software image and the software update image that when applied to the en software image updates that image to the software update image, calculates respective update times to transfer the software update image and the patch via the low-throughput channel to the end host and to apply the image and patch at the end host and pushes the software update image or patch having the shortest update time over the low-throughput channel to the RPC for storage in the RPC memory. The RPC processor applies the patch if received to the current software image to create and store the software update image or simply stores the received software update image and replaces the current software image with the software update image to operate the RPC. The same approach may be used to push a software update image to a power supply.

### BRIEF DESCRIPTION OF THE SEVERAL VIEWS OF THE DRAWINGS

In order that the advantages of the invention will be readily understood, a more particular description of the invention briefly described above will be rendered by reference to specific, embodiments that are illustrated in the appended drawings. Understanding that these drawings depict only embodiments of the invention and are not therefore to be considered to be limiting of its scope, the invention will be described and explained with additional specificity and detail through the use of the accompanying drawings, in which:

FIG. 1 is a high-level block diagram showing one example of a computer-network architecture where an apparatus and method in accordance with the invention may be implemented;

FIG. 2 is a diagram showing one example of a remote server pushing a new software update image to a local server which manages and pushes the software update image or patch over the low bandwidth, low throughput channel to the end host;

FIG. 3 is a high-level flow diagram showing one example of a method for pushing a software update image from a remote server through a local server to an end host in which transfer and application of the update is managed at the local server;

FIG. 4 is a diagram showing one example of normal message traffic between a local server and end host over a low bandwidth, low throughput channel in which the normal message traffic is interrupted to transfer and apply the software update image;

FIG. 5 is a high-level functional block diagram of a portion of the local server showing one example for managing the transfer and application of the update image;

FIG. 6 is a high-level functional block diagram of a portion of the end host showing one example for receiving and applying the update image or patch; and

FIG. 7 is a block diagram of a local storage system where an apparatus and method in accordance with the invention may be implemented to update software on the rack power controller or power supply.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

In view of the foregoing, various system embodiments for updating software including software for controlling high-level functionality or firmware for controlling low-level hardware functionality on end hosts in computing environments and particularly storage environments in which the transfer of a software update image to an end host via low-throughput channels would disrupt the end host's normal message traffic are provided. A remote server pushes the software update image to and through a local server via a network connection and high-throughput channels and to the end host via low-throughput channels. The local server manages the update process; the remote server simply pushes the software update image and the end host simply receives and applies an update. The local server stores the current software image running on the end host and decides whether it is more efficient to simply send the software update image on or to create send and apply a patch at the end host. This approach reduces the update time of the end host, reduces any disruption of normal message traffic to and from the end host and simplifies patch management.

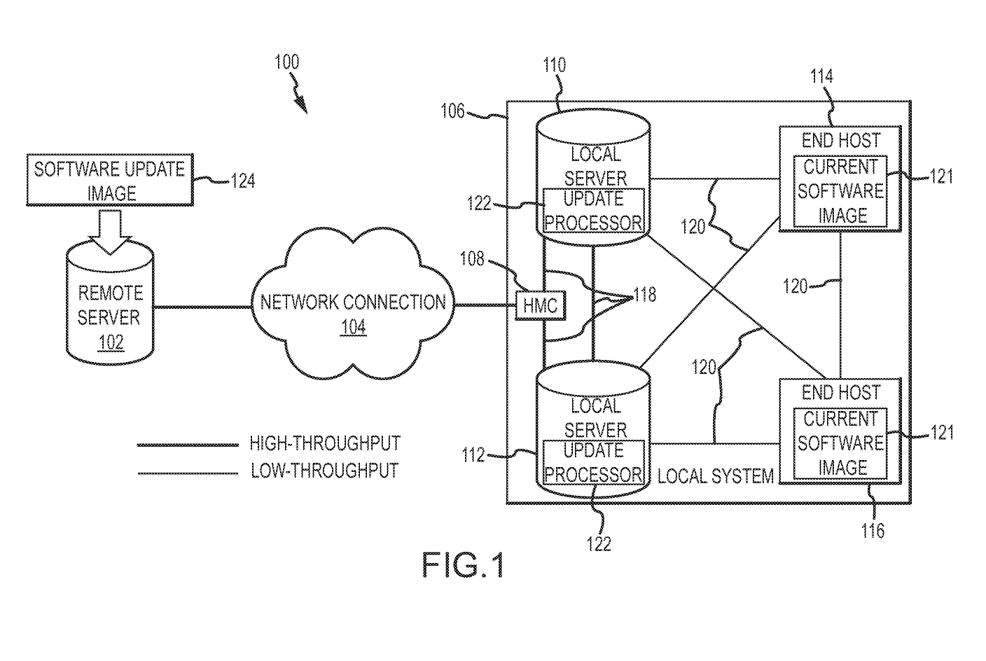

FIG. 1 shows one embodiment of a computer-networked architecture 100 in which a remote server 102 is connected through a network connection 104 to a local system 106. The network connection 104 may include, for example, a LAN, a WAN, the Internet, an intranet, or the like. These high-throughput network connections have throughputs in excess of 100 MB/sec (megabyte per second) or 1 GB/sec (gigabyte per second). Local system 106 comprises a hardware management controller (HMC) 108 that provides an interface to the customer, a pair of redundant local servers 110 and 112 and a pair of redundant end hosts 114 and 116. A “redundant” architecture is common but not required for application of the inventive method.

HMC 108 and local servers 110 and 112 are interconnected via high-throughput channels 118 such as Ethernet or Fibre channel to move large amounts of data quickly to satisfy customer demands. Typical channels have throughputs in excess of 100 MB/sec or 1 GB/sec.

An “end host” 114 or 116 may be any electronic hardware device such as a power controller, power supply or the like for which a software update is intended. Typically, the end host operates semi-autonomously from the local servers so that the normal message traffic is infrequent and small. Large amounts of data are not typically passed between the local server and end host. For example, the end host may periodically receive a status query from the local server and send a status response that the end host is present and operational. Accordingly, the end hosts are interconnected to the servers via low-throughput channels 120 such as a two-wire 12C bus to support the normal message traffic. A typical I2C bus has a maximum throughput of approximately 100 kB/sec. Such low-throughput channels are much less expensive and more than adequate to handle the normal message traffic. The effective throughput of the I2C bus between the local server and the end host may be much lower. The end hosts typically have limited processing power and memory speed, which slows the effective speed of the bus. As such, the high-throughput channels exhibit a throughput that is at least one hundred times the throughput of the low-throughput channel.

In this redundant system, each end host 114 and 116 is the same hardware device and runs the same software or firmware, referred to as the “current software image” 121. The end hosts for various reasons may or may not be running the same update of the current software image at all times. In other systems, different end hosts may be different hardware devices that run different current soft ware images.

In accordance with the system and methods of the present invention, the local server comprises an update processor 122 that is tasked with managing the update process of the current software image running on the end host The update processor may be a dedicated processor(s) or may constitute a portion of the processing capability of another processor(s). The local server stores a copy of the current software image 121 running on the end host in local memory. The update processor and copy of the current software image generally reside in the local system at a point above all of the low-throughput channels 120. Furthermore, the update processor and copy of the current software preferably reside as close to the end host as possible within the local system to simplify the local management of the update process. To update the end host, a software update image 124 is pushed via the high-throughput channels 118 to the local server where update processor 122 manages the task of updating the current software image 121 on the end host to the updated software image 124 via the low-throughput channels 120.

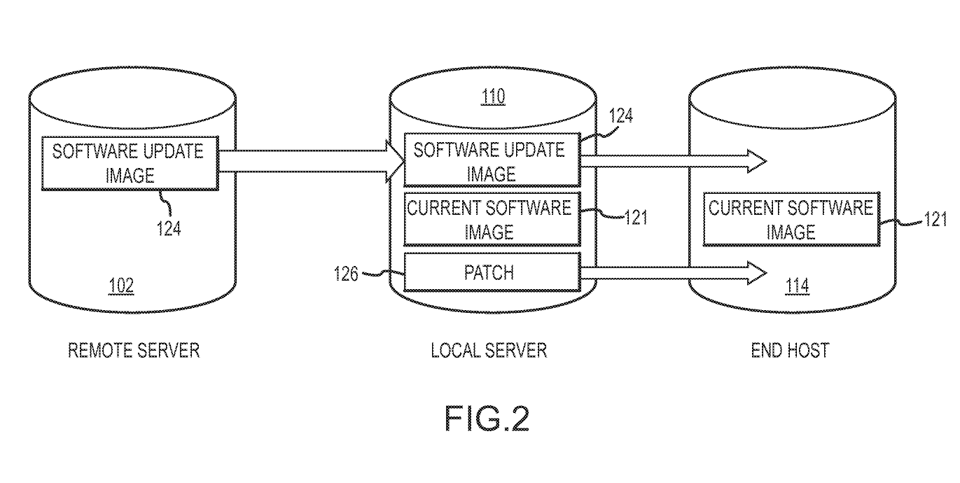

Referring now to FIGS. 1 and 2, software update image 124 on remote server 102 is pushed via high-throughput network connection 104 and high-throughput channels 118 to local server 110. The local server creates a patch 126 from the current software image 121 and software update image 124 that when applied to the current software image 121 updates that image to software update image 124. The local server then determines whether it is more efficient to transfer software update image 124 or to transfer patch 126 and apply patch 126 to the current software image 121 at end host 114. As illustrated, the remote server simply pushes the update out over the network connection and the end host simply receives the image or patch and applies the patch to update the current software image. The local server maintains only the current software image running on the end host. Once the update is complete, the local server replaces the current software image with the software update image and deletes the patch. This architecture relieves the remote server from having to account for all the different software versions running on all the different end hosts and relieves the end host, which typically has limited processing and memory resources, from managing its own update process. Management is performed at the local server which resides above all of the low-throughput channels and has ample processing and memory resources to manage the update process for the limited number of end hosts that are connected to the local server.

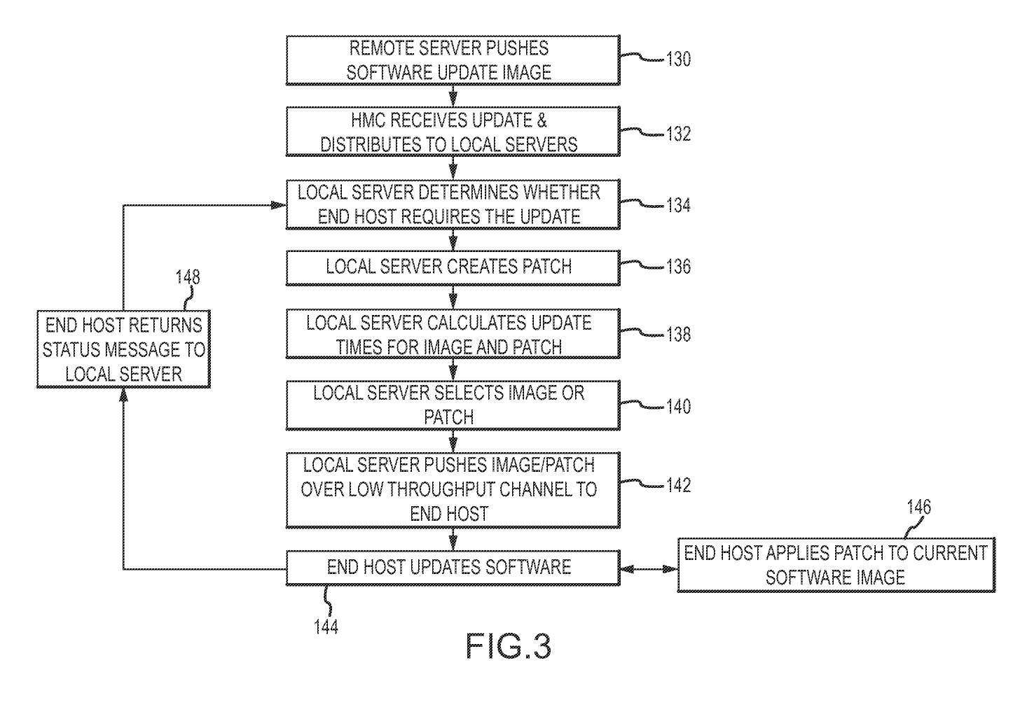

Referring now to FIGS. 1 and 3, to update the current software image 121 running on the end host, remote server 102 pushes software update image 124, may or may not be provided with a version indicator, over the network connection 104 to local system 106 (step 130). HMC 108 receives software update image 124 and distributes the image via high-throughput channels 118 to local servers 110 and 112 (step 132). The local server determines whether the end host requires the update or not (step 134). It is possible in a redundant system that some but not all of the end hosts are already running the current software. The local server may make this determination by, for example, comparing the version of the current software image and the update image or by comparing the images themselves. Assuming an update is required, the local server creates patch 126 from the current software image 121 and software update image 124 (step 136). The local server calculates respective update times for the software update image and the patch (step 138). The update time includes both the time to transfer the image or patch over the low-throughput channel to the end host and the time to apply the patch at the end host. The local server selects the image or patch mode of transfer having the shortest update time (step 140) and then pushes the selected image or patch over the low throughput channel to the end host (step 142). The end host updates the current software image 121 to the software update image 124 (step 144) by either applying the patch if received to the current software image 121 to create and store the software update image 124 (step 146) or simply storing the received software update image 124. The end host replaces the current software image with the software update image to operate the end host. Once complete, the end host returns a status message to the local server indicating that the update has been successful (step 148). At this point, the local server determines whether another end host requires the same or different update (step 134). Once complete, the local server may replace the current software image with the software update image and delete the patch. As such the local server need only maintain a copy of the current software image for any end host it services.

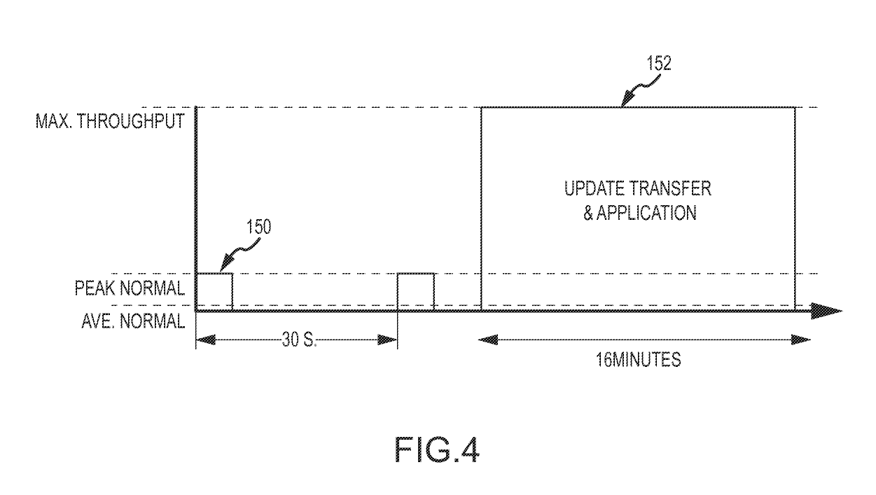

FIG. 4 depicts traffic on the low-throughput channel between the local server and the end host. In an embodiment, an I2C channel, where the bandwidth, i e. the maximum amount of data that can be moved through the channel, is 92 kB and the throughput, i.e. the maximum rate at which data can be moved through the channel is 92 kB/s (the 8-bit vide bus operates 92 kHz). The effective throughput is limited, to about 1 kB/s by the end host's processing and memory resources to turn around a packet. Under normal conditions, the local server and end host exchange a status request and status response 150 periodically, perhaps every 30 seconds, simply to verify to the local server that the end host is present and operational. If there are any problems at the end host, the end host may return certain error messages in the response. The average normal traffic over the I2C bus is approximately 32 B every 30 seconds. The peak traffic is 32 B, which is far less than the maximum payload of a typical packet of 255 B. Therefore, the normal message traffic may, in this example, be sent in one packet every 30 seconds.

Now assume a fairly small software update image size of 1 MB. The transfer time for the software update image from the remote server to the local server over the high-throughput channels (e. 100 MB/s or greater) is a fraction of a second, which should not disrupt other message/data traffic over the network connection or message/data traffic to and from the local servers on the high throughput channels. The transfer and application time 152 for the software update image from the local server to the end host over the low-throughput channels (e.g. 1 kB/s effective) is approximately 17 minutes. Application time of the image is assumed to be zero. If normal message traffic is suspended to transfer the image (as is the case in many architectures), the end host is offline for 17 minutes during which the part of the system served by the end hosts is no longer redundant. This is highly undesirable. Mitigating the amount of time redundancy is sacrificed is important.

A patch to a 1 MB image reflecting a simple code change (prior to compilation) may be about 20 kB. More complex code changes may produce larger patches. The transfer time for this patch across the low-throughput channel is approximately 20 seconds. By itself the transfer of the patch would cause minimal or no disruption of normal message traffic. However, the end host must apply the patch to the current software image to build the software update image. The end host remains offline until application is complete. The time to complete the application will depend on both the size and complexity of the patch and the processing and memory resources of the end host.

Based on knowledge of the algorithm that was used to create and thus apply the patch, the size and possibly the complexity of the specific patch, and the processing and memory resources of the end hosts, the local server can calculate an estimate of the patch application time at the end host. The local server than compares the total update time for the patch (sum of the transfer time plus the application time) to the transfer time for the update software image and selects the shorter update time of the two. The suggested approach is guaranteed to he no slower than the conventional approach of simply passing the software update image through to the end host in all cases and can be substantially faster for small, less complex patches. The transfer efficiency may be enhanced by using a particular class of patch algorithms whose efficiency of applying the patch scales linearly with the site of the patch

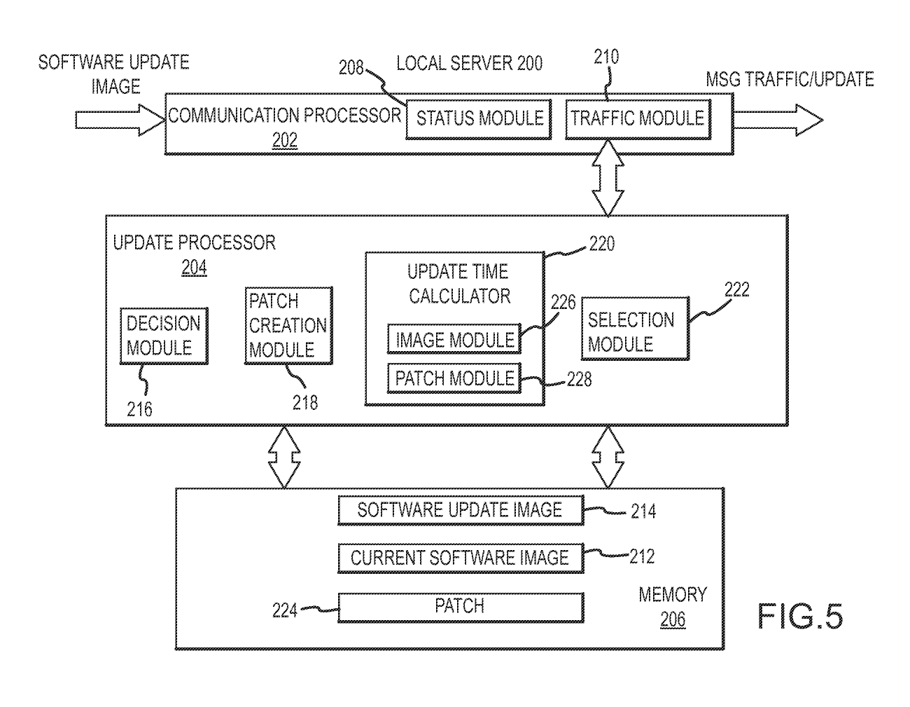

FIG. 5 shows a functional block diagram of an embodiment of a portion of a local server 200 configured to manage the updating of software on an end host. Local server 200 comprises a communication processor 202, an update processor 204 and memory 206. Communication processor 202 comprises a status module 208 that periodically generates status request for the end host and periodically receives a status response from the end host and a traffic module 210 that inserts the status request into a packet and sends it over the low-throughput channel to the end host and removes the status response from a return packet and forwards the response to the status module. A current software image 212 running on the end host is stored in memory 206. A software update image 214 provided by the remote server is routed to and stored on memory 206

Update processor 204 comprises a decision module 216, patch creation module 218, an update time calculator 220 and a selection module 222. Decision module 216 determines whether the end host requires the update provided by software update image 214. Decision module 216 may compare version numbers for the current software image and software image or may directly compare the images. Assuming an update is warranted, patch creation module 216 creates a patch 224 that when applied to current software image 212 reproduces software update image 214. Patch creation module 216 may be configured to provide side-information regarding the size and complexity of the patch.

Techniques for creating and applying patches for software images exist and are implemented in tools such as bsdiff, Xdelta and RTPatch. A class of patch algorithms is highly efficient in both the memory and processing requirements for applying the patch at the end host. The patch is created prior to initiation of the update process, so the processing time and memory required by the algorithm at the local server is not considered. The bsdiff tool as described in Colin Percival, “Naïve differences of executable code”, http://www.daemonology.net/bsdiff/, 2003 and Percival C. “Matching with Mismatches and Assorted Applications”, Doctoral Dissertation, University of Oxford, 2006, which is hereby incorporated by reference, is one example of such an algorithm. Essentially, the processing time and amount of memory to apply the patch grows linearly with the combined size of the current software image and the patch. In other patch algorithms, the processing time grows non-linearly with patch size. The use of “linear” patch algorithms reduces the time to apply a patch.

Update time calculator 220 comprises an image module 226 that calculates an image update time to transfer the software update image to the end host and a patch module 228 that calculates a patch update time to transfer the patch to the end host and to apply the patch. To calculate the image update time, image module 226 simply divides the size of software update image 214 by the effective throughput of the low-throughput channel. To calculate the patch update time, patch module 228 divides the size of patch 224 by the effective throughput of the low-throughput channel and adds a patch application time.

The actual patch application time depends on a number of factors including the type of patch algorithm (e.g. linear), the size and complexity of the patch and the processing and memory resources of the end host. As discussed above, a linear patch algorithm is highly efficient in terms of the processing and memory complexity. The larger the patch and the more complex the patch (e.g. the number of discontinuous segments) the longer the application time. Lastly, if the end host has limited processing and memory resources the patch application will take longer.

Patch module 228 may calculate the patch update time using various approaches including direct calculation, benchmarking and simulation. In one embodiment, direct calculation based on the type of patch algorithm, size and complexity of the patch and processing and memory resources of the end host may provide an estimate of the patch update time. In another embodiment, the local server's update processor can perform the same steps as the end host and apply the patch to the current software image to produce the software update image. A benchmarking test is performed prior to this, one that establishes the approximate processing time of both the server processor and the end host processor with respect to the operations that will be required to apply a patch. By additionally taking into account the memory access rates and throughput on both the server and the end host, an estimate of the end host's patch application time can be gathered from the server performing the patch update locally and prior to determining wind) update mode will be more time efficient. In another embodiment, the local server can simulate the architecture of the end host in order to determine the running time, in clock, cycles, of the patch update process. A software simulator of the end host's architecture can exactly determine the number of clock cycles that will be required to apply the patch, by executing the instructions required to apply the patch and counting associated processor and memory operations and their associated clock cycles.

Selection module 222 compares the image update time and patch update time, selects the mode with the shortest update time and passes the selection back to the communication processor. The communication processor's traffic module 210 retrieves the corresponding software update image 214 or patch 224 from memory 206 and pushes the image or patch over the low-throughput channel to the end host. In certain architectures, the traffic module must suspend normal message traffic between the local server and the end host until the image/patch has been transferred and applied at the end host. In other architectures, the traffic module can break the image/patch into segments and time-multiplex those segments with the normal message traffic to avoid disruption.

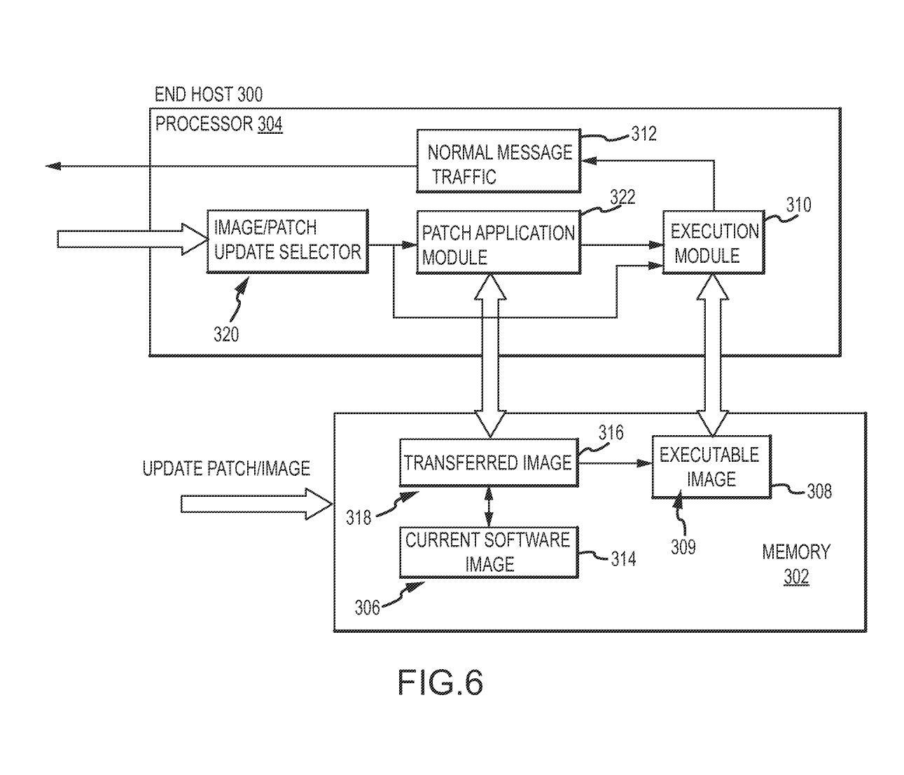

FIG. 6 shows a functional block diagram of an embodiment of a portion of an end host 300 configured to apply the update. End host 300 includes a memory 302 and a processor 304. For normal operation of the end host, a current software image is stored in a memory location 308 as the “executable image” 309. A processor execution module 310 runs the executable image 309 in memory location 308 to operate the end host including sending and receiving normal message traffic 312 with the local server.

To update the software, the current software image 306 is also stored in a memory location 314. The software update image or patch received from the local server is temporarily stored in a memory location 316 as a “transferred image” 318, if the transferred image is the software update image, it is simply moved to memory location 308 to replace the executable image and to memory location 314 to replace and become the current software image 306. If the transferred image 318 is the patch, an image/patch update selector 320 so indicates and a patch application module 322 applies the patch to the current software image in memory location 314 to reproduce and temporarily store the software update image in memory location 316. Once the application is complete, the software update image is moved to memory location 308 to replace the executable image and to memory location 314 to replace and become the current software image 306.

As described, the end host simply receives and applies the image/patch to update the software. The end host need not perform any of the overhead tasks of accounting, for software versions or managing the update process. This is particularly advantageous in architectures of the type described in which the end host resides behind low-throughput channels and has limited processing and memory resources.

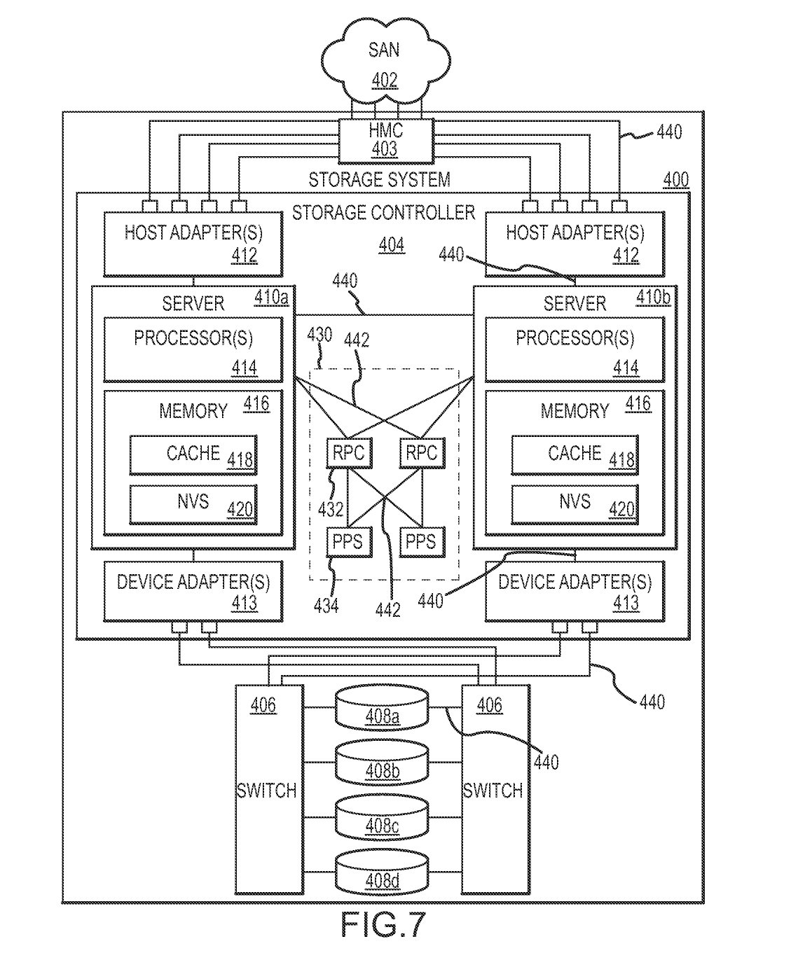

FIG. 7 shows one embodiment of a storage system 400 connected to a SAN 402. Storage system 400 contains an array of hard-disk drives (HDDs) and/or solid-state drives (SDDs) such as a RAID array. As shown, the storage system 400 includes a hardware management controller (HMC) 403, a storage controller 404, one or more switches 406, and one or more storage devices 408, such as hard disk drives 408 or solid-state drives 408. The storage controller 404 may enable one or more hosts (e,g, open system and/or mainframe servers) to access data in one or more storage devices 406.

In selected embodiments, the storage controller 404 includes one or more local servers 410. The storage controller 404 may also include host adapters 412 and device adapters 413 to connect to host devices and storage devices 408, respectively. Multiple local servers 410a, 410b may provide redundancy to ensure that data is always available to connected hosts. Thus, when one server 410a fails, the other server 410b may remain functional to ensure that I/O is able to continue between the hosts and the storage devices 408. This process may he referred to as a “failover.”

One example of a storage controller 404 having architecture similar to that illustrated in FIG. 7 is the IBM DS8000™ enterprise storage system. The DS8000™ is a high-performance, high-capacity storage controller providing disk storage that is designed to support continuous operations. The DS8000™ series models may use IBM's POWER5™ servers 410a, 410b, which may be integrated with IBM's virtualization engine technology. Nevertheless, the software update apparatus and methods disclosed herein are not limited to the IBM DS8000™ enterprise storage system 400, but may be implemented in comparable or analogous storage systems, regardless of the manufacturer, product name, or components or component names associated with the system Furthermore, any system that could benefit from one or more embodiments of the invention is deemed to hill within the scope of the invention. Thus, the IBM DS8000™ is presented only by way of example and is not intended to be limiting.

In selected embodiments, each server 410 may include one or more processors 414 (e.g., n-way symmetric multiprocessors) and memory 416. The memory 116 may include volatile memory (e.g., RAM) as well as non-volatile memory (e.g., ROM, EPROM, EEPROM, hard disks, flash memory, etc.). The volatile memory and non-volatile memory may, in certain embodiments, store software modules that run on the processor(s) 414 and are used to access data in the storage devices 408. The servers 410 may host at least one instance of these software modules. These software modules may manage all read and write requests to logical volumes in the storage devices 408.

The memory 416 includes a volatile cache 418 and non-volatile storage 420. Whenever a host (e.g., an open system or mainframe server) performs a read operation, the servers 410 may fetch data from the storages devices 408 and save data in the cache 418 in the event the data is required again. If the data is requested again by a host, the server 410 may fetch the data from the cache 418 instead of fetching it from the storage devices 408, saving both time and resources.

Storage system 400 also includes a power subsystem 430 that provides power to the various components of the system. Power subsystem 430 comprises multiple redundant rack power controllers (RPCs) 432 and multiple redundant primary power supplies 434. The RPC is a communications controller for the power subsystem of the DS8000 enterprise storage system. The RPC formats and routes data between the various entities of the power subsystem and the local servers. [symbol] The Primary Power Supply (PPS) is a modular power supply, providing power (11.5 kW) for use by all the various components of the DS8000 enterprise storage system, including the local servers, drives, RPCs, batteries, etc.

To facilitate the rapid transfer of large amounts of data, the HMC 403, storage controller 404 (and all of its components), switches 406 and storage devices 408 are all interconnected via high-throughput channels 440 such as Ethernet or Fibre Channel. The RPCs and PPSs do not transfer large amounts of data, their normal communication is quite limited. Consequently the RPCS and PPSs are interconnected to each other and local servers 410a and 410b via low-throughput I2C buses 442.

When the software for the HMC, storage controller (and all of its components), switch or storage devices must be updated, the software update image is simply pushed from the remote server through the high-throughput channels to the final destination or “end host” where the image is loaded and executed. The network connection of the SAN and the Ethernet or Fibre Channel connections are at least 100 MB/sec and thus the software update can occur very quickly with no disruption to normal message traffic or data transfer.

When the software for the RPC or PPS must be updated, the software update image is pushed from the remote server through the high-throughput channels to local servers 410a and 410b where it is stored in memory 416. The current software image running on the “end hosts” (RPCs or PPPs) serviced by the local server is also stored in memory 416. The local processors 414 are configured to implement the “update processor” as previously described. The update processor creates a patch, calculates the update times for the image and patch and selects the mode with the shortest update time. The processor than pushes the image or patch through the I2C bus 442 to the end host, be it the RPC or PPS. The RPC or PPS processor applies the image or patch to updates its current software image.

In the specific embodiment contemplated, in which the “end host” is an RPC or a PPS, the software update image constitutes a firmware update image and, in fact, the only firmware executed by the end host.

As will be appreciated by one of ordinary skill in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Aspects of the present invention are described below with reference to flowchart illustrations and/or block diagrams of methods, apparatus (systems) and computer program products according, to embodiments of the invention. It will be understood that each block of the flowchart illustrations and/or block diagrams, and combinations of blocks in the flowchart illustrations and/or block, diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block, diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the above figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “Comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended, to be exhaustive or limited to the invention it the form disclosed. Many modifications and variations will be apparent to those of ordinary skill in the art without departing from the scope and spirit of the invention. The embodiment was chosen and described in order to best explain the principles of the invention and the practical application, and to enable other of ordinary skill in the art to understand the invention for various embodiments with various modifications as are suited to the particular use contemplated.

What is claimed is:

1. An apparatus for updating software at an end host, comprising:
a software update image;
a local system at a local customer site, said local system comprising a hardware management controller (HMC), one or more local servers each comprising an update processor and a memory, and one or more end hosts comprising a memory that stores a current software image and a processor that executes that image to operate the end host including communicating normal message traffic with the local server, said local server memory storing a copy of the current software image running on the end host, said HMC and said local servers interconnected via high-throughput channels with said end hosts connected to said local servers via low-throughput channels;
a network connection to the local system;
a remote server that pushes the software update image over the Network connection to the local system, said HMC distributing the software update image via said high-throughput channels to said local servers for storage in their memory;
said local server's update processor creating a patch from said current software image and said software update image that when applied to said current software image updates that image to said software update image, calculating respective update times to transfer the software update image and the patch via the low-throughput channel to the end host and to apply the image and patch at the end host and pushing the software update image or patch having the shortest update time over the low-throughput channel to the end host for storage in the end host memory; and
said end host processor applying the patch if received to the current software image to create and store the software update image else storing the received software update image and replacing the current software image with the software update image to operate the end host

2. The apparatus of claim 1, wherein the one or more high-throughput channels have a throughput of at least one hundred times the throughput of the one or more low-throughput channels.

3. The apparatus of claim 2, wherein the low-throughput channels comprise an I2C two-wire bus and the high-throughput channels comprise an Ethernet connection or fibre channel.

4. An apparatus for updating software, comprising:
a software update image for a rack power controller;
a local storage system at a local customer site, said local system comprising a hardware management controller (HMC), one or more local servers each comprising an update processor and a memory, one or more storage devices, one or more rack power controllers (RPCs) comprising a memory that stores a current software image and a processor that executes that image to operate the RPC including, communicating normal message traffic with the local server., and one or mote power supplies, said local setter memory storing a copy of the current software image running on the RPC said HMC, local servers and storage devices interconnected via high-throughput channels with said power supplies and said RPCs interconnected to said local servers via low-throughput channels;
a network connection to the local storage system;
a remote server that pushes the software update image over the Network connection to the local storage system, said HMC distributing the software update image via said high-throughput channels to said local servers for storage in their memory;
said local server's update processor creating a patch from said current software image and said software update image that when applied to said current software image updates that image to said software update image, calculating respective update times to transfer the software update image and the patch via the low-throughput channel to the RPC and to apply the image and patch at the RPC and pushing the software update image or patch having the shortest update time over the low-throughput channel to the RPC for storage in the RPC memory;
said RPC processor applying the patch if received to the current software image to create and store the software update image else storing the received software update image and replacing the current software image with the software update image to operate the RPC.

5. The apparatus of claim 4, wherein the one or more high-throughput channels have a throughput of at least one hundred times the throughput of the one or more low-throughput: channels.

6. The apparatus of claim 4, wherein the software update image constitutes firmware that is the only firmware executed by the RPC processor.

7. The apparatus of claim 4, wherein said local server's update processor uses a patch algorithm to create the patch whereby the time to apply the patch is linearly proportional to the size of the patch.
